(19) United States
(12) Patent Application Publication
(10) Pub. No.: US 2013/0059231 A1
(43) Pub. Date: Mar. 7, 2013

(54) CORE-SHELL STRUCTURED ELECTROCATALYSTS FOR FUEL CELLS AND PRODUCTION METHOD THEREOF

(71) Applicants: Seung Jun HWANG, Seoul (KR); Soo-Kil KIM, Seoul (KR); Sung Jong YOO, Incheon (KR); Jong Hyun JANG, Seoul (KR); Eun Ae CHO, Seoul (KR); Hyoung-Juhn KIM, Gyeonggi-do (KR); Suk-Woo NAM, Seoul (KR); Tae Hoon LIM, Seoul (KR)

(72) Inventors: Seung Jun HWANG, Seoul (KR); Soo-Kil KIM, Seoul (KR); Sung Jong YOO, Incheon (KR); Jong Hyun JANG, Seoul (KR); Eun Ae CHO, Seoul (KR); Hyoung-Juhn KIM, Gyeonggi-do (KR); Suk-Woo NAM, Seoul (KR); Tae Hoon LIM, Seoul (KR)

(73) Assignee: KOREA INSTITUTE OF SCIENCE AND TECHNOLOGY

(21) Appl. No.: 13/403,130

(22) Filed: Feb. 23, 2012

(30) Foreign Application Priority Data
Sep. 5, 2011 (KR) 10-2011-0089780

(51) Int. Cl. H01M 4/92; B01J 37/00; B01J 37/08; B01J 23/89; B01J 23/42; B01J 23/44; B01J 23/755; B01J 23/72; H01M 4/90; B01J 23/46; B82Y 40/00; B82Y 30/00

(52) U.S. Cl. 429/524; 429/525; 429/526; 429/527; 502/300; 429/523; 502/331; 502/325; 502/339; 502/326; 502/337; 502/345; 977/773; 977/896; 977/810; 977/948

(57) ABSTRACT

Disclosed is a method for producing a core-shell structured electrocatalyst for a fuel cell. The method includes uniformly supporting nano-sized core particles on a support to obtain a core support, and selectively forming a shell layer only on the surface of the core particles of the core support. According to the method, the core and the shell layer can be formed without the need for a post-treatment process, such as chemical treatment and heat treatment. Further disclosed is a core-shell structured electrocatalyst for a fuel cell produced by the method. The core-shell structured electrocatalyst has a large amount of supported catalyst and exhibits superior catalytic activity and excellent electrochemical properties. Further disclosed is a fuel cell including the core-shell structured electrocatalyst.

### CROSS-REFERENCE TO RELATED APPLICATIONS

This application claims priority under 35 U.S.C. §119 to Korean Patent Applications No. 10-2011-0089780 filed on Sep. 5, 2011 in the Korean Intellectual Property Office, the disclosure of which is incorporated herein by reference in its entirety.

### BACKGROUND OF THE INVENTION

1. Field of the Invention

The present invention relates to core-shell structured electrocatalysts for fuel cells and a method for producing the same.

2. Description of the Related Art

A fuel cell is a device in which electrical energy is generated by an electrochemical reaction between a fuel and an oxidizing agent. The fuel cell uses hydrogen as a fuel, oxygen as an oxidizing agent, and electrodes consisting of an anode acting to catalyze a hydrogen oxidation reaction (HOR) and a cathode acting to catalyze an oxygen reduction reaction (ORR). The electrodes of the fuel cell are also called electrocatalysts for their catalytic activities. Each of the electrocatalysts is produced by supporting catalytic particles on a support, such as carbon.

Platinum is usually used as a catalytic material for electrocatalysts of fuel cells. However, platinum is expensive and has a problem of low acceptable value for impurities. Under these circumstances, many studies have been conducted on the production and use of electrocatalysts that use a reduced amount of platinum and provide better electrochemical activity and stability than pure platinum. Most of such studies propose approaches to enhance the inherent activity of platinum or electrocatalysts in the form of alloys of platinum and transition metals. Core-shell structured electrocatalysts have recently attracted increasing attention due to their particularly high electrochemical activity and stability.

In the production of core-shell structured electrocatalysts, however, it is difficult to prepare nano-sized uniform core particles and it is also necessary to uniformly form a shell layer on the surface of the core particles. Particularly, when core particles are first supported on a support and a shell layer is then formed thereon, the shell layer is formed not only on the surface of the core particles but also on the surface of the support. That is, some of the shell layer-forming particles are supported on the surface of the support. This non-selectivity results in performance deterioration. In view of this situation, core-shell structured electrocatalysts are at present produced by a method including preparing nano-sized core particles, coating shell particles on the core particles to produce core-shell structured catalyst particles, and supporting the catalyst particles on a support. According to this method, the catalyst particles are supported on the support by physical binding between the catalyst particles and the support. This binding force is not sufficiently high. Alternatively, direct support of core particles on a support may be considered. In this case, since chemical bonds are formed between the support and the core particles, the core particles can be supported with much stronger binding force. Furthermore, a much larger amount of the particles will be able to be supported.

Additives, such as stabilizers or dispersants, are currently used for the uniformity of core particles and the formation of uniform shell layers in the course of forming core and shell structures. Since such additives as stabilizers affect the reactivity of catalysts and impede the formation of shell layers on the surface of core particles, they are removed by chemical treatment or heat treatment in a subsequent step. However, during such chemical treatment or heat treatment, the core particles tend to aggregate or deform, and aggregation of particles or collapse is likely to occur in the shell layers, leading to poor activity of electrocatalysts.

On the other hand, the problem of cathode degradation under shutdown/startup conditions was observed 20 years ago, but only limited methods are available to improve the selectivity of anode catalysts. This is because there are extremely few combinations of active sites necessary to obtain maximum reaction rates of ORR and HOR, thus making it very difficult to design selective anode catalysts.

Markovic et al. have attempted to overcome such shutdown/startup problems by chemical modification of Pt using a particular material, such as calix[4]arene [Nature Materials Vol. 9, December 2010, 998-1003, Angew. Chem. Int. Ed. 2011, 50, 1-6]. However, this attempt has problems, such as complicated processes, and is thus difficult to practice in reality.

### SUMMARY OF THE INVENTION

It is, therefore, an object of the present invention to provide a method for preparing core nanoparticles supported on a support for a core-shell structured electrocatalyst by chemical bonding between the core nanoparticles and the support without the use of a stabilizer, thus being advantageous in terms of the amount of supported catalyst and stability. It is another object of the present invention to provide a method for producing a core-shell structured electrocatalyst for a fuel cell by which a shell layer can be selectively formed on core particles without chemical treatment and heat treatment.

It is another object of the present invention to provide an electrocatalyst for a fuel cell that has a large amount of supported catalyst and exhibits superior catalytic activity, and a fuel cell including the electrocatalyst. It is a particular object of the present invention to provide an anode with excellent selective characteristics and a fuel cell including the anode.

In accordance with an aspect of the present invention, there is provided a method for preparing core nanoparticles supported on a support for a core-shell structured electrocatalyst, the method including (a) reacting a support with a precursor of at least one core-forming metal in an ether-based solvent.

The use of the ether-based solvent in the method of the present invention was confirmed to enable support of uniform nano-sized core particles on the support without the need to use any stabilizer, such as oleylamine, that conventionally causes problems, such as aggregation or deformation of particles, during removal of the stabilizer. Examples of ether-based solvents suitable for use in the method of the present invention include, but are not limited to, benzyl ether, phenyl ether, dimethoxytetraglycol and furan-based aromatic ethers. These ether-based solvents may be used alone or as a mixture of two or more thereof.

In an embodiment, the reaction in step (a) is carried out at 80 to 120° C. It was confirmed that the degree of dispersion and the amount of supported catalyst are markedly improved at a reaction temperature of 80 to 120° C. compared to at room temperature.

In another embodiment, the core is composed of an alloy of Pd and Cu, and step (a) is carried out at room temperature. It was confirmed that even when the reaction is carried out at room temperature to form the core composed of an alloy of PD and Cu, a high degree of dispersion and a large amount of supported catalyst are obtained.

In accordance with another aspect of the present invention, there is provided a method for producing a core-shell structured electrocatalyst for a fuel cell, the method including (a) reacting a support with a precursor of at least one core-forming metal in an ether-based solvent to obtain core nanoparticles supported on the support, and (b) reducing a precursor of at least one shell-forming metal using an ester-based reducing agent in a solution in which the core nanoparticles supported on the support are dipped or dispersed.

The use of the ester-based reducing agent in the method of the present invention was confirmed to allow selective formation of a shell layer only on the surface of the core nanoparticles. Examples of ester-based reducing agents suitable for use in the method of the present invention include, but are not limited to, a Hantzsch ester of Formula 3:

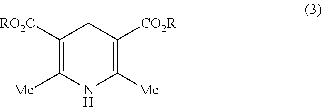

wherein each Me represents a methyl group and the two R groups, which may be identical to or different from each other, each independently represents a C₁-C₄ alkyl group, and derivatives thereof.

In an embodiment, the at least one core-forming metal may be selected from Pt, Pd, Ir, Ru, Rh, Os, transition metals, and alloys of two or more thereof. The at least one shell-forming metal may be selected from Pt, Pd, Ir, Ru, Rh, Os, transition metals, and alloys of two or more thereof. In a preferred embodiment, the at least one core-forming metal may be selected from Pt, Pd, Ir, Ni, Cu and alloys of two or more thereof. The at least one shell-forming metal may be selected from Pt, Pd, Ir, Ni, Cu, and alloys of two or more thereof.

The core-shell structured electrocatalyst produced according to exemplary embodiments of the present invention may be used as an anode. In this case, the anode was confirmed to exhibit selective catalytic characteristics. Particularly, an anode produced using Pd as the at least one core-forming metal and an alloy of Pd and Ir as the at least one shell-forming metal was confirmed to exhibit new selective catalytic characteristics and extremely high values thereof, demonstrating selective physical properties, as presented in the following examples section.

In accordance with another aspect of the present invention, there is provided a core-shell structured electrocatalyst for a fuel cell, including (A) a support, (B) core nanoparticles supported on the support, and (C) a shell layer selectively formed on the surface of the core nanoparticles, wherein the core is composed of at least one metal or alloy selected from Pt, Pd, Ir, Ru, Rh, Os, transition metals and alloys of two or more thereof, and the shell layer consists of one or more layers, each of which is composed of at least one metal or alloy selected from Pt, Pd, Ir, Ru, Rh, Os, transition metals and alloys of two or more thereof.

As used herein, the expression “the shell layer is selectively formed on the surface of the core nanoparticles supported on the support” has the same meaning as “the shell layer is not substantially formed on the support but is selectively formed only on the surface of the core nanoparticles,” which is intended to include “the case where the shell layer is not formed on the support and is exclusively formed only on the surface of the core nanoparticles” and should be interpreted to further include “the case where the shell layer is substantially selectively formed only on the surface of the core nanoparticles,” as considered from the viewpoint of one skilled in the art to which the invention pertains.

Specifically, “the case where the shell layer is substantially selectively formed only on the surface of the core nanoparticles,” as considered from the viewpoint of one skilled in the art may correspond to the case where, for example, 90% or more, preferably 95% or more, more preferably 99% or more of a precursor of the shell-forming metal is formed into the shell layer on the core nanoparticles, but is not necessarily limited to this case. In other words, “the case where the shell layer is substantially selectively formed only on the surface of the core nanoparticles,” as considered from the viewpoint of one skilled in the art may correspond to the case where, for example, 10% or less, preferably 5% or less, more preferably 1% or less of a precursor of the shell-forming metal is formed on the support, but is not necessarily limited to this case.

In a preferred embodiment, the core is composed of at least one metal or alloy selected from the group consisting of Pt, Pd, Ir, Ni, Cu and alloys of two or more thereof, and the shell layer is composed of at least one metal or alloy selected from the group consisting of Pt, Pd, Ir, Ni, Cu and alloys of two or more thereof.

In an embodiment, the core is composed of an alloy of Pd and Cu, and the shell layer is composed of Pt.

In a further embodiment, the shell layer consists of a first shell layer directly formed on the core and a second shell layer formed on the first shell layer. Particularly, in a specific embodiment, the core, the first shell layer and the second shell layer are composed of Pd, Au and Pt, respectively. In another specific embodiment, the core is composed of Pd and the shell layer is composed of an alloy of Pd and Ir.

In accordance with another aspect of the present invention, there is provided an electrode for a fuel cell which includes the core-shell structured electrocatalyst according to the exemplary embodiments. It is obvious that the electrode may be selectively used as an anode or a cathode depending on the characteristics of the electrocatalyst. Specifically, the core-shell structured electrocatalyst including the core composed of Pd, the first shell layer composed of Au and the second shell layer composed of Pt is preferably used as a cathode. The core-shell structured electrocatalyst including the core composed of Pd and the shell layer composed of an alloy of Pd and Ir is preferably used as an anode.

In accordance with yet another aspect of the present invention, there is provided a core-shell structured electrocatalyst for a fuel cell which includes (A) a support and (B) a plurality of core-shell structured catalysts supported on the support wherein the cores are composed of Pd and the shells are composed of an alloy of Pd and Ir. The core-shell structured electrocatalyst of the present invention may be used as an anode for a fuel cell.

The core-shell structured electrocatalyst according to the above aspect of the present invention may be Pd@Pd—Ir, which is not necessarily produced by the method of the present invention. That is, the core-shell structured electrocatalyst in which the cores are composed of Pd and the at least one shell-forming metal is an alloy of Pd and Ir may not be produced by the method presented in the present invention. In this case as well, the core-shell structured electrocatalyst exhibits selective anode catalytic characteristics although data thereof are not explicitly presented in the present invention. However, it was confirmed that Pd@Pd—Ir produced by the method of the present invention has maximized anode catalytic characteristics.

As presented above, the attempt of Markovic et al. to overcome shutdown/startup problems has been directed toward inhibiting unnecessary ORR while maintaining HOR at a level similar to that of Pt. In contrast, the present invention has a significant meaning in that a highly selective metal combination exhibiting a high HOR level, such as Pd@Pd—Ir disclosed in the present invention, was found from metal combinations having low ORR levels. As well, the present invention has a more significant meaning in that the selectivity of the core-shell structured electrocatalyst produced according to the exemplary embodiments of the present invention was confirmed to be markedly maximized.

The method for the production of a core-shell structured electrocatalyst according to the present invention eliminates the need for heat treatment or chemical treatment, which has conventionally been performed to remove a stabilizer, after formation of a core and a shell layer. This is advantageous in terms of processing and can prevent particles from aggregation or deformation during heat treatment or chemical treatment. In addition, deformation of a core-shell structure after formation of a shell layer and degradation of catalytic activity and electrochemical properties caused by deformation can be prevented. Furthermore, according to the present invention, uniform nano-sized core particles are supported on a support, and a shell layer is selectively and uniformly formed only on the surface of the supported core particles. Therefore, according to the present invention, a core-shell structured electrocatalyst for a fuel cell can be produced in which a shell layer is selectively and uniformly formed only on the surface of nano-sized core particles having a uniform particle size supported on a support. The electrocatalyst can be used in both an anode and a cathode for a fuel cell. The electrocatalyst has a large amount of supported catalyst and exhibits superior catalytic activity and excellent electrochemical properties.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIGS. 1a to 1f are TEM images of core supports produced in Comparative Examples 1-1 to 1-6, respectively;

FIGS. 2a to 2c are TEM images showing results obtained after chemical treatment of core supports with acetic acid (AcOH), hydrazine and KCN, respectively;

FIGS. 3a to 3c are TEM images of core supports produced in Examples 1-1 to 1-3, respectively;

FIGS. 4a and 4b are TEM images of catalysts produced in Comparative Example 2 and Example 2-1a, respectively;

FIG. 5 is a CV curve of a catalyst produced in Example 2-2;

FIG. 6 shows IV curves of a catalyst produced in Example 2-1a and a commercial catalyst;

FIG. 7 is an ORR graph of catalysts produced in Examples 2-1a and 2-2 and a commercial catalyst;

FIG. 8 is a graph showing the catalytic activity of a catalyst produced in Example 2-1a per unit mass;

FIG. 9 is an ORR graph of catalysts produced in Examples 2-1a, 2-1b and 2-1c; and

FIGS. 10a to 10c are graphs showing results obtained after stability testing on a catalyst produced in Example 2-1a.

### DETAILED DESCRIPTION OF THE INVENTION

The present invention provides a method for producing an electrocatalyst for a fuel cell in which a core-shell structured catalyst is supported on a support. Specifically, the method includes reacting a support with a precursor of a core-forming metal in an ether-based solvent to form a core support, and reacting the core support with a precursor of a shell-forming metal in the presence of an ester-based reducing agent. The first step is to uniformly support the core-forming metal in the form of nanoparticles on the support, and the second step is to uniformly coat the surface of the core particles of the core support with the shell-forming metal.

The method of the present invention is based on the finding that when a support reacts with a precursor of a core-forming metal in an ether-based solvent without using a stabilizer to form a core, nano-sized core particles having a uniform particle size can be uniformly supported on the support. The method of the present invention is also based on the finding that when an ester-based reducing agent is used in the reaction for the formation of a shell layer on the core support in which the nano-sized core particles are uniformly supported on the support, a shell layer is selectively formed only on the surface of the core particles.

According to the present invention, there is no need for post-treatment (heat treatment or chemical treatment) to remove a stabilizer in the course of forming a core-shell structure, and core particles can be directly supported on a support to produce a core-shell structured electrocatalyst consisting of a nano-sized core uniformly supported on the support and a shell layer formed on the surface of the core. Therefore, an electrocatalyst produced by the present invention has a large amount of supported catalyst and exhibits superior catalytic activity and excellent electrochemical properties.

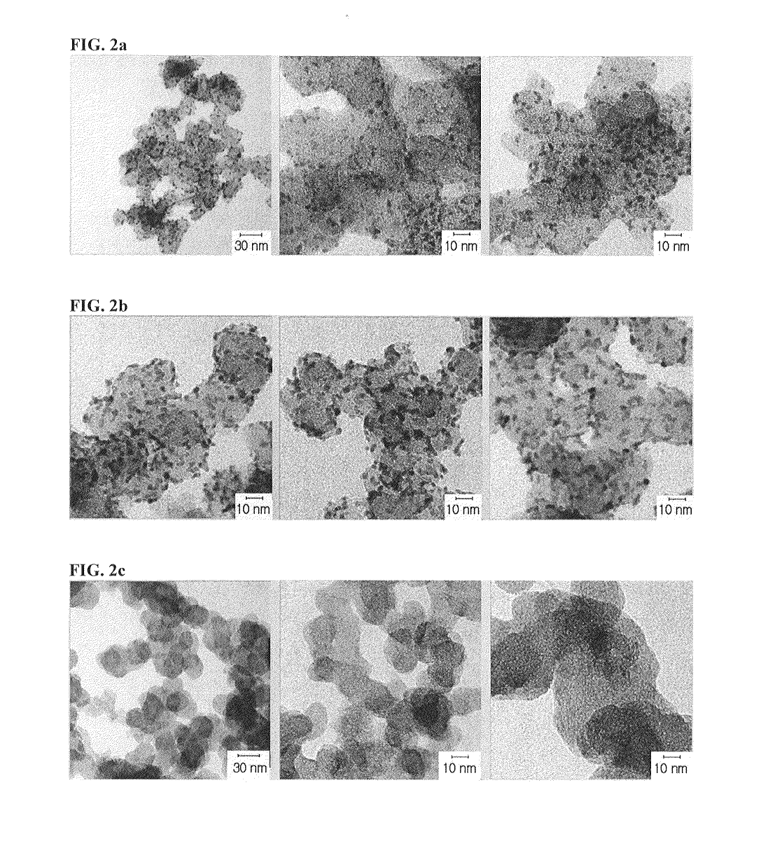

According to a conventional method for producing a core-shell structured electrocatalyst, a stabilizer, such as oleylamine or cetyltrimethylammonium bromide (CTAB), is used in a reaction for the formation of a core. The reason for the use of the stabilizer is to facilitate dispersion of a core-forming metal while surrounding the surface of the core-forming metal to allow for a stable and slow reduction reaction of the metal. Accordingly, the use of the stabilizer enables the formation of core particles having a uniform particle size. However, the stabilizer may remain unremoved on the surface of the core particles, impeding the formation of a shell layer in the subsequent step. There is thus a need to remove the stabilizer remaining on the surface of the core particles. A post-treatment process, such as chemical treatment with acetic acid, hydrazine, TEAOH, TMAOH, KCN or a compound having a short amine chain, or heat treatment is required to remove the stabilizer. During post-treatment, however, the particles tend to aggregate and deform (see FIGS. 2a to 2c). In conclusion, the use of the stabilizer makes it impossible to obtain substantially uniform formation of the core particles (i.e. monodispersion of the core material). In a state in which the core particles are not uniformly formed, a shell layer also cannot be uniformly formed on the surface of the core particles. As a result, a final electrocatalyst does not exhibit satisfactory performance characteristics in terms of the amount of supported catalyst, catalytic activity and electrochemical properties.

In contrast, according to the present invention, nano-sized core particles can be uniformly supported on a support even without the use of a stabilizer for the formation of a core. This can avoid the need for post-treatment, which is a common process for the removal of a stabilizer, thus being advantageous in terms of processing, and can maintain the form of core particles supported on a support unchanged.

The core formation reaction in the method of the present invention is characterized in that an ether-based solvent is used instead of an alcohol-based solvent so that a nano-sized core having a uniform particle size can be formed even without the use of a stabilizer. The ether-based solvent used in the core support formation reaction is believed to act as a kind of stabilizer to enable slow reduction of a metal precursor. The ether-based solvent is easy to remove by simply washing with ethanol, unlike stabilizers that have been widely used in the art. In addition, since the short carbon chain of the ether-based solvent is not thought to cause problems in the subsequent reaction, there is no particular need to remove the ether-based solvent. Furthermore, it was confirmed that even when the reaction for supporting core particles on a support is carried out at room temperature, core particles can be formed by the reduction of a metal precursor [see Example 1-3].

There is no restriction on the kind of the ether-based solvent used in the present invention. As the ether-based solvent, there may be used, for example, benzyl ether of Formula 1, phenyl ether, dimethoxytetraglycol of Formula 2 or a furan-based aromatic ether.

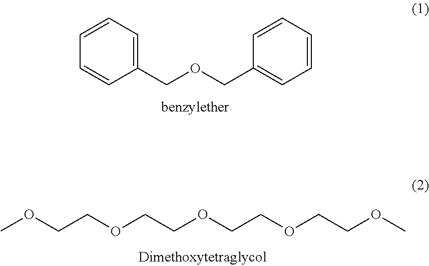

A core metal in the form of nanoparticles supported on a support may be ruthenium, rhodium, palladium, gold, silver, iridium, copper, nickel, iron, osmium, platinum or an alloy of two or more thereof. The core metal is preferably selected from the group consisting of palladium, copper, iridium and alloys thereof. The support is preferably a carbon support, such as activated carbon or carbon black. As a precursor of the metal, a metal acetate may be used. For example, when the metal is platinum, the metal precursor may be, for example, PtCl₄, H₂PtCl₆.6H₂O, PtCl₂(C₆H₅CN)₂, Pt(CH₃COCHCOCH₃)₂ or K₂PtCl₆. When the metal is iridium, the metal precursor may be, for example, IrCl₃, H₂IrCl₆.XH₂O, IrCl₃.XH₂O, Ir(CH₃COCHCOCH₃)₃ or K₂IrCl₆.

A reducing agent may be additionally used in the core formation reaction. As the reducing agent, there can be used an ammonia borane compound, such as t-butylamine borane, to improve the efficiency of the reaction.

Next, the reaction for the formation of a shell layer on the core support is characterized in that a shell-forming metal precursor is reduced with an ester-based reducing agent to selectively form a uniform shell layer only on the surface of the core particles of the support.

The selective shell layer formation reaction is effected by reducing the shell layer-forming metal using the Hantzsch ester of Formula 3 or a derivative thereof as the reducing agent.

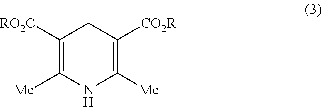

wherein each R is independently C₁-C₄ alkyl.

It is known that the Hantzsch ester is widely used for slow transfer hydrogenation in organic chemical reactions depicted below:

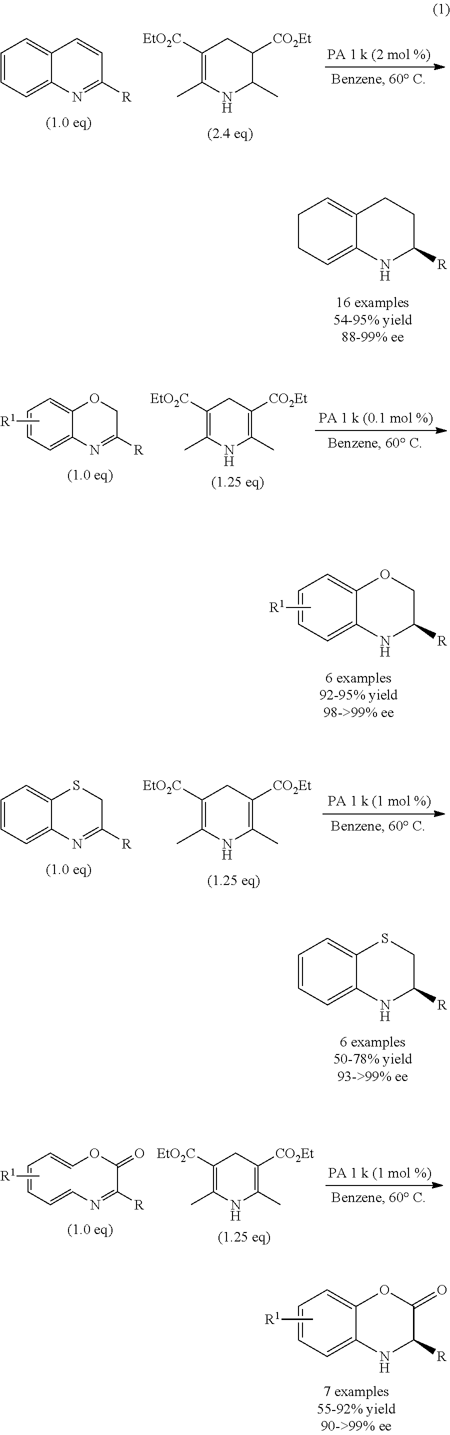

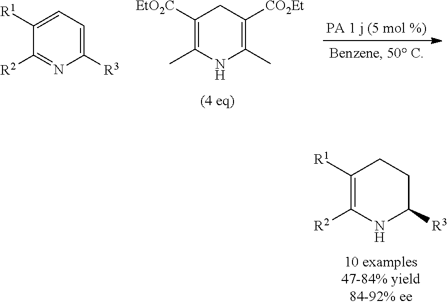

The Hantzsch ester reduces the shell layer-forming metal precursor at a much slower rate than a polyol method, which is a conventional method for the formation of a shell layer, a reduction method using an acid, such as ascorbic acid or citric acid, or a reduction method using a reducing agent, such as NaBH₄. This slow reduction enables selective formation of the shell layer only on the surface of the core particles. A problem of a conventional method for the formation of a shell layer is that shell-forming metal particles are coated on the surface of a support as well as on the surface of core particles. In contrast, according to the present invention, it was confirmed that the shell layer is selectively and uniformly formed only on the surface of the core particles [see FIG. 4b].

In the shell layer formation reaction, the use of the Hantzsch ester or its derivative for slow transfer hydrogenation eliminates the need to use a stabilizer, which has been used in the art, as in the previous core formation reaction, and further avoids the need to perform a post-treatment process for the removal of a stabilizer on the surface of the shell layer.

According to a conventional method, a stabilizer used in a reaction for the formation of a shell layer remains on the surface of a final core-shell structure to cause degradation of the activity and electrochemical properties of the catalyst. Thus, thermal treatment or chemical treatment is required to remove the stabilizer, as described above. However, deformation of the core-shell structure tends to occur during post-treatment, leading to degradation in the activity and electrochemical properties of the catalyst. In contrast, according to the present invention, no stabilizer is used in the shell layer-forming reaction. This eliminates the need to perform a post-treatment process and is thus advantageous in terms of processing. It is, of course, possible to prevent not only deformation of the core-shell structure that may be caused during post-treatment but also degradation of catalytic activity and electrochemical properties caused by deformation.

A metal used for the formation of the shell layer may be ruthenium, rhodium, palladium, gold, silver, iridium, copper, nickel, iron, osmium, platinum or an alloy of two or more thereof, which is the same as the core-forming metal. Preferred is palladium, iridium, gold or an alloy thereof. A metal acetate may be used as the precursor of the metal. For example, when the metal is platinum, the metal precursor may be, for example, PtCl₄, H₂PtCl₆.6H₂O, PtCl₂(C₆H₅CN)₂, Pt(CH₃COCHCOCH₃)₂ or K₂PtCl₆. When the metal is iridium, the metal precursor may be, for example, IrCl₃, H₂IrCl₆.XH₂O, IrCl₃.XH₂O, Ir(CH₃COCHCOCH₃)₃ or K₂IrCl₆.

The present invention also provides an electrocatalyst produced by the method of the present invention. The electrocatalyst has a core-shell structure in which core particles are uniformly formed (i.e. the core material is monodispersed) on a support to form a core support and a shell layer is selectively and uniformly coated only on the surface of the core particles to produce a core-shell structured catalyst supported on the support. The electrocatalyst may be used in both a cathode and an anode of a fuel cell. That is, the electrocatalyst may be used as a catalyst for hydrogen oxidation reaction or oxygen reduction reaction in a fuel cell depending on what catalyst material is selected. For example, when the core is composed of palladium or a palladium alloy and the shell layer is composed of platinum, the electrocatalyst acts as a catalyst for oxygen reduction reaction. Alternatively, when the core is composed of palladium or a palladium alloy and the shell layer is composed of iridium, the electrocatalyst acts as a catalyst for hydrogen oxidation reaction.

In the production of the electrocatalyst of the present invention, ruthenium, rhodium, palladium, gold, silver, iridium, copper, nickel, iron, osmium, platinum or an alloy of two or more thereof may be used as a core-forming metal or shell-forming metal. Preferably, the core-forming metal is palladium or an alloy of palladium with one or more other metal. As metals capable of alloying with palladium, various kinds of metals can be used, for example, copper (Cu), nickel (Ni), iridium (Ir), molybdenum (Mo), indium (In), rhodium (Rh), rhenium (Re), cobalt (Co) and iron (Fe). Particularly, an alloy of palladium and copper shows good results in core formation even when the reaction is carried out at room temperature.

A feature of the present invention resides in the use of the method in which core particles are directly supported on a support to produce a core-shell structured catalyst from the core-forming step. A difference between a conventional method for supporting a final core-shell structured catalyst on a support and the method employed in the present invention is that the core-shell structured catalyst particles are supported on the support by physical bonding and the core particles are supported on the support by chemical bonding. From this difference, it is obvious that the present invention brings about much better results in terms of the amount of supported catalyst and stability. The reason for supporting the core particles on the support from the core-forming step in the present invention is explained by the fact that the shell layer can be selectively formed only on the surface of the core particles in the subsequent shell layer-forming step.

The conventional method has been used in view of the problem that shell layer-forming metal particles are seated on the surface of a support as well as on the surface of core particles supported on the support. The problem is more serious because a shell layer is preferentially formed on the support rather than on the surface of the core particles due to chemical bonding between the particles supported on the support surface and the support. In contrast, according to the present invention, after core particles are supported on a support, it is possible to carry out the reaction for the formation of a shell layer on the surface of the core particles supported on the support because the shell layer is selectively formed only on the surface of the core particles.

The present invention will be explained with reference to the following examples.

### Production of Core Supports—with Use of Stabilizer

### Comparative Example 1-1

### Pd/C

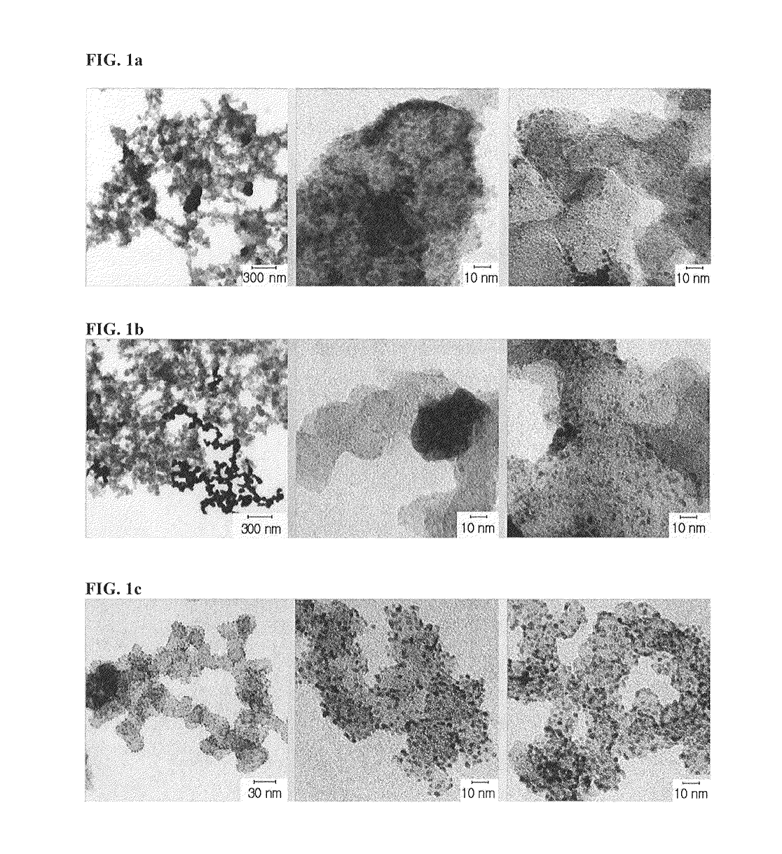

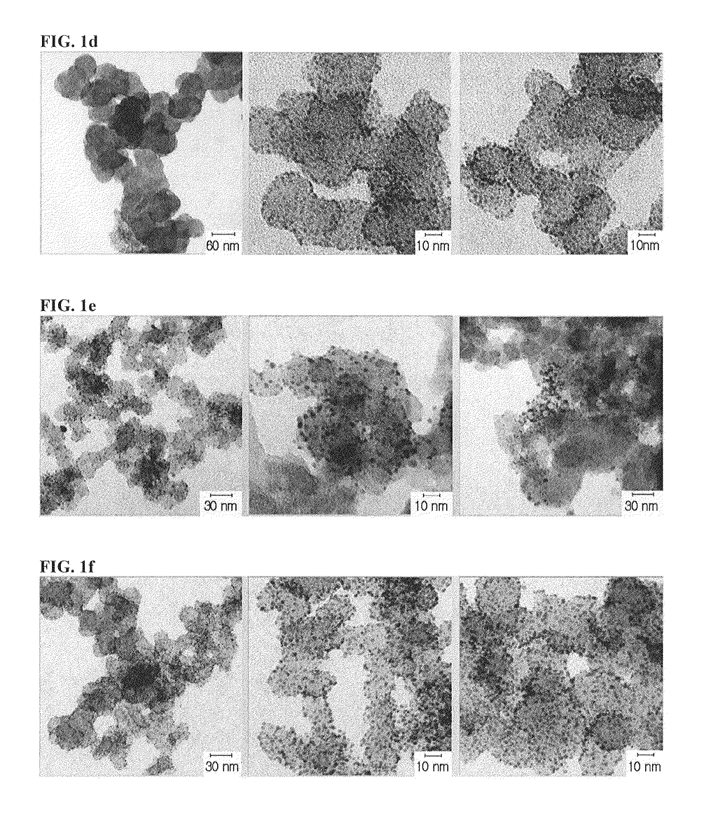

Carbon Vulcan-XC 72R as a support, palladium acetylacetonate (Pd(acac)₂) as a precursor of a core-forming metal, NaBH₄ as a reducing agent and oleylamine as a stabilizer were reacted in 1,2-propanediol as a solvent at room temperature for 2-12 hr to produce a core support. Images of the core support were taken by transmission electron microscopy (TEM) [FIG. 1a].

### Comparative Example 1-2

### Pd/C

A core support was produced in the same manner as in Comparative Example 1-1, except that t-butylamine borane was used as a reducing agent instead of NaBH₄ and the reaction was carried out at a temperature of 95° C. Images of the core support were taken by TEM [FIG. 1b].

### Comparative Example 1-3

### Pd/C

Carbon Vulcan-XC 72R as a support, palladium acetylacetonate (Pd(acac)₂) as a precursor of a core-forming metal, t-butylamine borane as a reducing agent and oleylamine as a stabilizer were reacted in benzyl ether as a solvent at room temperature for 2-12 hr to produce a core support. Images of the core support were taken by TEM [FIG. 1c].

### Comparative Example 1-4

### Pd₃Ni₁/C

A core support was produced in the same manner as in Comparative Example 1-3, except that palladium acetylacetonate (Pd(acac)₂) and nickel acetylacetonate (Ni(acac)₂) were used as precursors of core-forming metals. Images of the core support were taken by TEM [FIG. 1d].

### Comparative Example 1-5

### Pd₄Ir₆/C

A core support was produced in the same manner as in Comparative Example 1-3, except that palladium acetylacetonate (Pd(acac)₂) and iridium acetylacetonate (Ir(acac)₃) were used as precursors of core-forming metals and the reaction was carried out at a temperature of 95° C. Images of the core support were taken by TEM [FIG. 1e].

### Comparative Example 1-6

### Pd₄Ir₆/C

A core support was produced in the same manner as in Comparative Example 1-3, except that palladium acetylacetonate (Pd(acac)₂) and iridium chloride (IrCl₃) were used as precursors of core-forming metals and the reaction was carried out at a temperature of 95° C. Images of the core support were taken by TEM [FIG. 1f].

### Chemical Treatments for Removal of Stabilizer

The core supports prepared in the Comparative Examples were treated with acetic acid at 70° C. and hydrazine and KCN at room temperature. The respective results are shown in FIGS. 2a to 2c.

### Production of Core Supports—without Using Stabilizer

### Example 1-1

### Pd/C

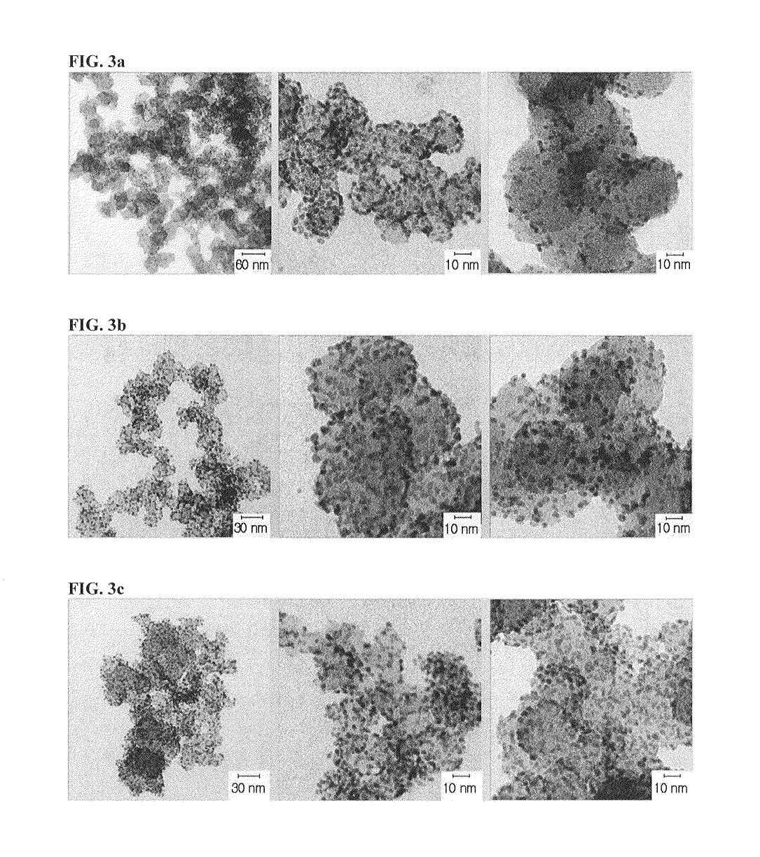

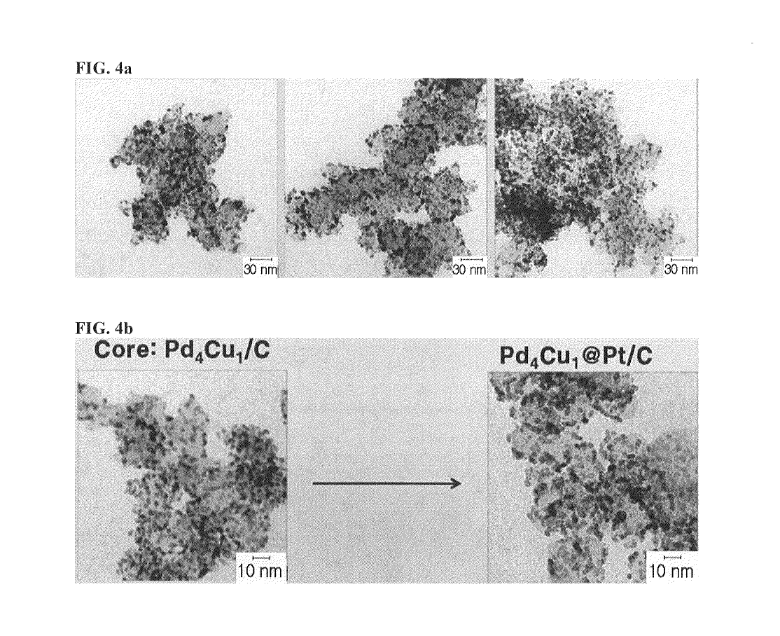

Carbon Vulcan-XC 72R as a support, palladium acetylacetonate (Pd(acac)₂) as a precursor of a core-forming metal and t-butylamine borane as a reducing agent were reacted in benzyl ether as a solvent at room temperature for 4-12 hr to produce a core support. Images of the core support were taken by TEM [FIG. 3a].

### Example 1-2

### Pd/C

A core support was produced in the same manner as in Example 1-1, except that the reaction was carried out at a temperature of 100° C. Images of the core support were taken by TEM [FIG. 3b].

### Example 1-3

### Pd₃Cu₁/C

A core support was produced in the same manner as in Example 1-1, except that palladium acetylacetonate (Pd(acac)₂) and copper acetylacetonate (Cu(acac)₂) were used as precursors of core-forming metals. Images of the core support were taken by TEM [FIG. 3c].

The TEM images of the core supports produced in the Comparative Examples were compared with those of the core supports produced in the Examples. Nano-sized core particles were not properly formed in the core supports produced using the diol as a solvent in Comparative Examples 1-1 and 1-2.

In the core supports produced using benzyl ether as a solvent in Comparative Examples 1-3 to 1-6, nano-sized core particles were formed and their uniformity was also confirmed to be satisfactory to some extent. However, Ir was not sufficiently reduced even at a high temperature (95° C.) in the core support produced in Comparative Example 1-5, while nanoparticles having a uniform particle size were formed in the core support produced using IrCl₃ in Comparative Example 1-6. These results indicate that when the ether-based solvent was used as a solvent in the conventional method using a stabilizer, core particles could be properly formed only from some of the metal precursors.

In contrast, it was confirmed that nano-sized core particles were properly formed in the core supports produced using no stabilizer in the Examples. Particularly, the core support produced using no stabilizer in Example 1-1 was confirmed to show a degree of dispersion and the amount of supported catalyst comparable to the core support produced using the stabilizer under the same conditions in Comparative Example 1-3. Furthermore, it was confirmed that the increased reaction temperature in Example 1-2 led to a further improvement in the degree of dispersion and the amount of supported catalyst.

As well, it was confirmed that the palladium/copper alloy core support showed markedly improved results in terms of degree of dispersion and the amount of supported catalyst although the reaction was carried out at room temperature.

### Formation of Shell Layers—Production of Catalysts

### Comparative Example 2

### Pd₃Cu₁@Pt/C

50 mg of the core support produced in Example 1-3 was sufficiently dispersed in 150 ml of anhydrous ethanol. To the dispersion was added a solution of 124.3 mg (1.5 eq. of core) of hexachloroplatinic acid (H₂PtCl₆.6H₂O, Alfa Aesar) as a shell-forming metal precursor in 50 mL of anhydrous ethanol to form a shell layer, completing the production of a catalyst. The reaction was carried out at a temperature of 80° C. for 2 hr in the presence of a solution of ascorbic acid (211.3 mg, 5 eq. of Pt precursor) as a reducing agent in 20 mL of anhydrous ethanol. Images of the catalyst were taken by TEM [FIG. 4a].

### Example 2-1a

### Pd₃Cu₁@Pt/C (1.5 eq. Pt)

50 mg of the core support produced in Example 1-3 was sufficiently dispersed in 150 ml of anhydrous ethanol. To the dispersion was added a solution of 124.3 mg (1.5 eq. of core) of hexachloroplatinic acid (H₂PtCl₆.6H₂O, Alfa Aesar) as a shell-forming metal precursor in 50 mL of anhydrous ethanol to form a shell layer, completing the production of a catalyst. The reaction was carried out at a temperature of 80° C. for 2 hr in the presence of a solution of the Hantzsch ester of Formula 4 (5 eq. of Pt precursor, 1.2 mmol) as a reducing agent in 20 mL of anhydrous ethanol. Images of the catalyst were taken by TEM [FIG. 4b].

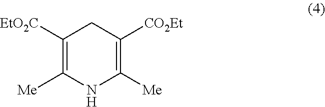 [SMILES: CCOC(=O)C1=C(C)NC(C)=C(C(=O)OCC)C1]

### Example 2-1b

### Pd₃Cu₁@Pt/C (1.0 eq. Pt)

A catalyst was produced in the same manner as in Example 2-1a, except that 82.9 mg (1.0 eq. of core) of hexachloroplatinic acid (H₂PtCl₆.6H₂O, Alfa Aesar) as a metal precursor was used to form a shell layer.

### Example 2-1c

### Pd₃Cu₁@Pt/C (0.7 eq. Pt)

A catalyst was produced in the same manner as in Example 2-1a, except that 58.0 mg (0.7 eq. of Core) of hexachloroplatinic acid (H₂PtCl₆.6H₂O, Alfa Aesar) as a metal precursor was used to form a shell layer.

### Example 2-2

### Pd@Au@Pt/C

50 mg of the core support produced in Example 1-2 was sufficiently dispersed in 150 ml of anhydrous ethanol. To the dispersion were added a solution of 93.2 mg (1.1 eq. of core) of hexachloroplatinic acid (H₂PtCl₆.H₂O, Alfa Aesar) and 23.6 mg (0.375 eq. of core) of HAuCl₄.H₂O as shell-forming metal precursors in 50 mL of anhydrous ethanol to form a shell layer. The reaction was carried out at a temperature of 80° C. for 2 hr in the presence of a solution of the Hantzsch ester of Formula 4 (5 eq. of Pt precursor, 1.2 mmol) as a reducing agent in 20 mL of anhydrous ethanol.

### Example 2-3

### Pd@Ir/C

50 mg of the core precursor produced in Example 1-2 was sufficiently dispersed in 100 ml of anhydrous ethanol. To the dispersion was added a solution of 62.9 mg (1.5 eq. of core) of iridium chloride (IrCl₃) as a shell-forming metal precursor in 50 mL of anhydrous ethanol to form a shell layer, completing the production of a catalyst. The reaction was carried out in the presence of a solution of the Hantzsch ester of Formula 4 (5 eq. of Ir precursor, 1.05 mmol) as a reducing agent in 20 mL of anhydrous ethanol.

### Example 2-4

### Pd@PdIr/C

50 mg of the core support produced in Example 1-2 was sufficiently dispersed in 150 ml of anhydrous ethanol. To the dispersion were added a solution of 27.4 mg (0.6 eq. of core) of potassium palladium chloride (K₂PdCl₄) and 37.6 mg (0.9 eq. of core) of iridium chloride (IrCl₃) as shell-forming metal precursors in 50 mL of anhydrous ethanol to form a shell layer, completing the production of a catalyst. The reaction was carried out at a temperature of 80° C. for 2 hr in the prescence of a solution of the Hantzsch ester of Formula 4 (4.8 eq. of Pt precursor, 1.05 mmol) as a reducing agent in 20 mL of anhydrous ethanol. An image of the catalyst was taken by TEM [FIG. 11b] and was compared with the TEM image of the Pd/C produced in Example 1-2 [FIG. 11a].

The core-shell structures of Comparative Example 2 and Example 2-1a [FIGS. 4a and 4b, respectively] were compared. In the core-shell structure of Comparative Example 2, the shell-forming metal was coated not only on the surface of the core particles but also on the area of the support after the metal precursor was reduced using ascorbic acid, and as a result, the shell layer was entirely formed thereon. In contrast, the image of the core-shell structure of Example 2-1a confirms that the shell layer was selectively formed only on the surface of the core particles after the metal precursor was reduced using the Hantzsch ester. These results lead to the conclusion that the method of the present invention allows selective formation of a shell layer only on the surface of core particles even in a state in which the core particles are supported on a support.

### Evaluation of Electrochemical Performance

Fabrication of Single Cells

To evaluate the performance of electrodes manufactured using the catalysts produced in the Examples, cells were constructed and their electrical properties were evaluated by the following procedures.

Anode: 0.2 mg/cm² Pt/C 40 wt % (Johnson-Matthey)

Cathode: 0.3 mg/cm² PdCu@Pt/C 40 wt %

Cell temperature: 70° C.

Anode line temperature: 75° C.

Cathode line temperature: 70° C.

Humidity: 100%

Activation conditions: activated by load cycling in oxygen

Anode flow: 150 sccm

Cathode flow: 800 sccm

Active area: 5 cm²

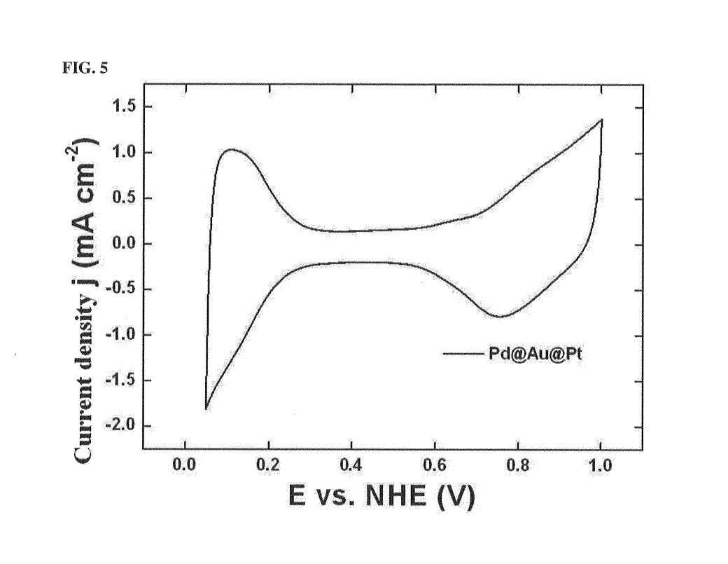

CV data [FIG. 5]

The activity of the catalyst produced in Example 2-2 was evaluated by cyclic voltammetry (CV). The results are shown in FIG. 5. A peak characteristic to Au was not observed, confirming that Au was not exposed to the surface of the catalyst. This demonstrates that the shell layer formed as a result of the reaction using the two kinds of precursors, Pt and Au, had a bilayer structure in which Au having a higher reduction potential was reduced first and Pt having a lower reduction potential was then reduced thereon.

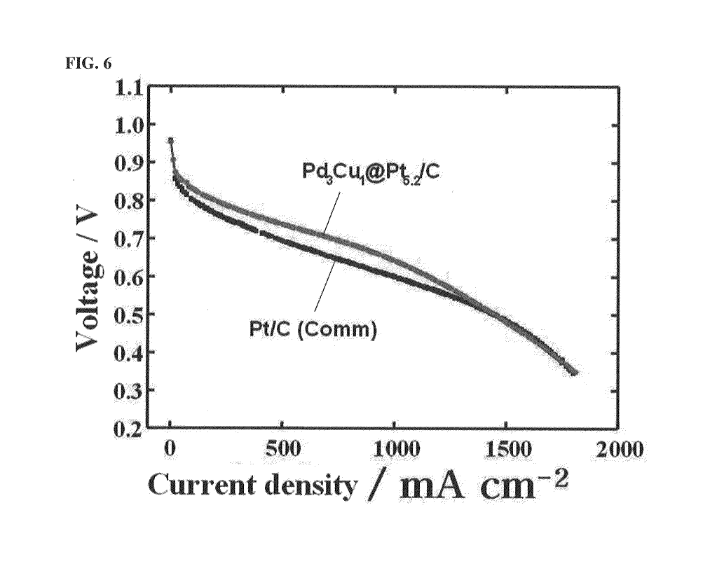

IV curves [FIG. 6]

Cells of the same type were fabricated using the catalyst produced in Example 2-1a and 40 wt % Pt/C (Johnson-Matthey) as a commercial catalyst. IV curves of the cells were plotted and are shown in FIG. 6.

In each of the cells, currents were measured at different voltages of 0.6 V, 0.7 V and 0.8 V. The results are shown in Table 1. The catalyst produced in Example 2-1a showed a higher current density than the commercial catalyst at the same voltage. These results indicate better activity of the catalyst produced in Example 2-1a than the commercial catalyst.

TABLE 1

| | Pt/C (JM) | Example 2-1a |
|---|---|---|
| 0.6 V | 1,000 mA/cm² | 1,155 mA/cm² |
| 0.7 V | 462 mA/cm² | 724 mA/cm² |
| 0.8 V | 98 mA/cm² | 197 mA/cm² |

Evaluation of Oxygen Reduction Reaction (ORR) Activity

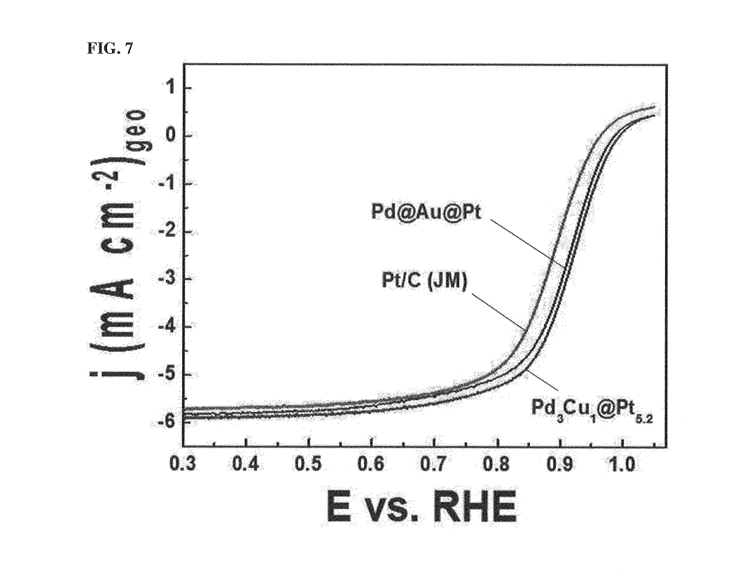

(1) Oxygen reduction reactions (ORRs) in the core-shell structured catalysts produced in Examples 2-1a and 2-2 and 40 wt % Pt/C (Johnson-Matthey) as a commercial catalyst were measured using a rotating disk electrode (RDE) system to evaluate the electrical activities of the catalysts per unit area. The results are shown in FIG. 7.

In FIG. 7, the x-axis represents voltage versus RHE and the y-axis represents active j [mA/cm²]_{geo} per unit area of electrode. The voltage of 0.6 V or lower is the diffusion-controlled current, the 0.7-0.8 V zone is the mixed kinetic-diffusion controlled region, and kinetic reactions exclusively occur at a voltage higher than 0.8 V. A higher absolute value of current at 0.9 V or 0.85 V indicates a faster oxygen reduction reaction.

As can be seen from FIG. 7, PdCu@Pt produced in Example 2-1a and PdCu@Pt@Au produced in Example 2-2 showed current densities of about 3.6 mA/cm² at 0.9 V versus RHE. These results indicate that the ORR activities of the inventive catalysts are 1.9 times higher than the ORR activity of the commercial catalyst, 40 wt % Pt/C (Johnson-Matthey).

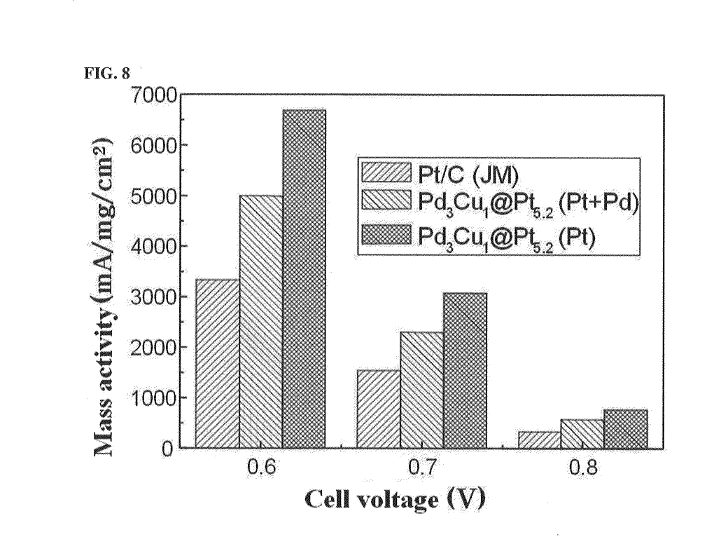

Meanwhile, FIG. 8 shows values obtained by dividing the current densities at particular voltages (0.6 V, 0.7 V and 0.8 V) by the mass of Pt or Pt+Pd to evaluate the catalytic activities of the catalyst of Example 2-1a and the commercial catalyst per unit mass from the data of FIG. 7. At least a 2-fold increase in the Pt mass and an about 1.4-fold increase in the mass of Pt+Pd were observed. These results indicate markedly improved catalytic activity of the metals used in the catalysts of Examples 2-1a and 2-2 compared to that of the commercial catalyst.

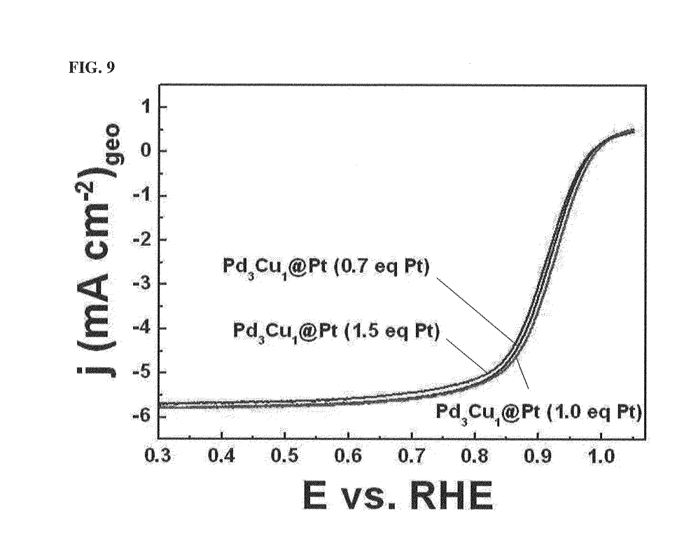

(2) The electrical activity of each of the catalysts produced in Examples 2-1a, 2-1b and 2-1c per unit area of the catalyst was measured. The results are shown in FIG. 9. The half wave potential of the catalyst produced using 1.0 eq. platinum for the formation of the shell layer was increased by 10 mV compared to that of the catalyst using 1.5 eq. platinum and was increased by 5 mV compared to that of the catalyst produced using 1.5 eq. platinum. These results indicate better performance of the catalyst produced using 1.0 eq. platinum. The excessive use (1.5 eq.) of the metal Pt for the formation of the shell layer is thought to cause bulk characteristics of Pt, and the use of a small amount (0.7 eq.) of Pt is thought to cause insufficient surrounding of the core particles by Pt, leading to slightly inferior performance. From these results, it can be concluded that a core-shell structured catalyst having preferred catalytic activity can be produced by controlling the amount of at least one shell layer-forming metal according to the invention.

The characteristics of the catalysts produced in Examples 2-1a, 2-1b and 2-1c were compared to those of commercial catalysts. The results are shown in Table 2. E_{1/2} is a potential value when the current density is half of the limiting current in the ORR graph. A higher E_{1/2} of a catalyst means a smaller over-potential applied in ORR, indicating good activity of the catalyst for oxygen reduction reaction. As can be seen from the results in Table 2, the inventive catalysts exhibit far superior performance to the commercial catalysts.

TABLE 2

| | | E_{1/2} (V vs. RHE) | I (mA/cm²) at |
|---|---|---|---|
| | | (the higher, | 0.9 V (the higher, |
| Catalyst | Manufacturer | the better) | the better) |
| PtNi/C | Argonne | 0.93 | — |
| PtML/Pd₂Au₁Ni₁ | Los Alamos | 0.87 | 2.0 |
| Pt on Pd nanorod | Brookhaven | 0.90 | 3.2 |
| Example 2-1a | KIST | 0.92 | 3.1 |
| Example 2-1b | KIST | 0.925 | 3.3 |
| Example 2-1c | KIST | 0.93 | 3.6 |

Stability Test

The catalyst produced in Example 2-1a was evaluated for stability. This stability test was conducted at an accelerated rate and results were obtained under extreme conditions (about 10-fold) compared to common stability tests. That is, it can be considered that the stability test was conducted for a 10-fold longer time than that shown in the graph. For example, 3,000 min (50 hr) in the 10-fold accelerated test corresponds to 500 hr in an actual stability test.

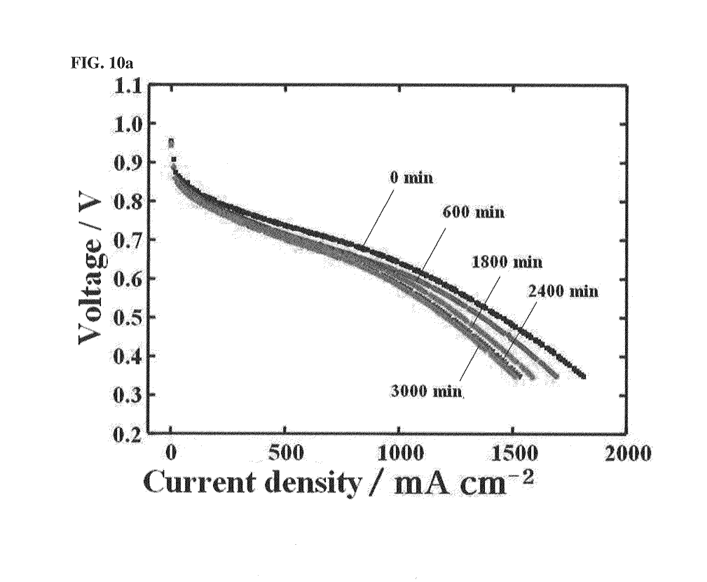

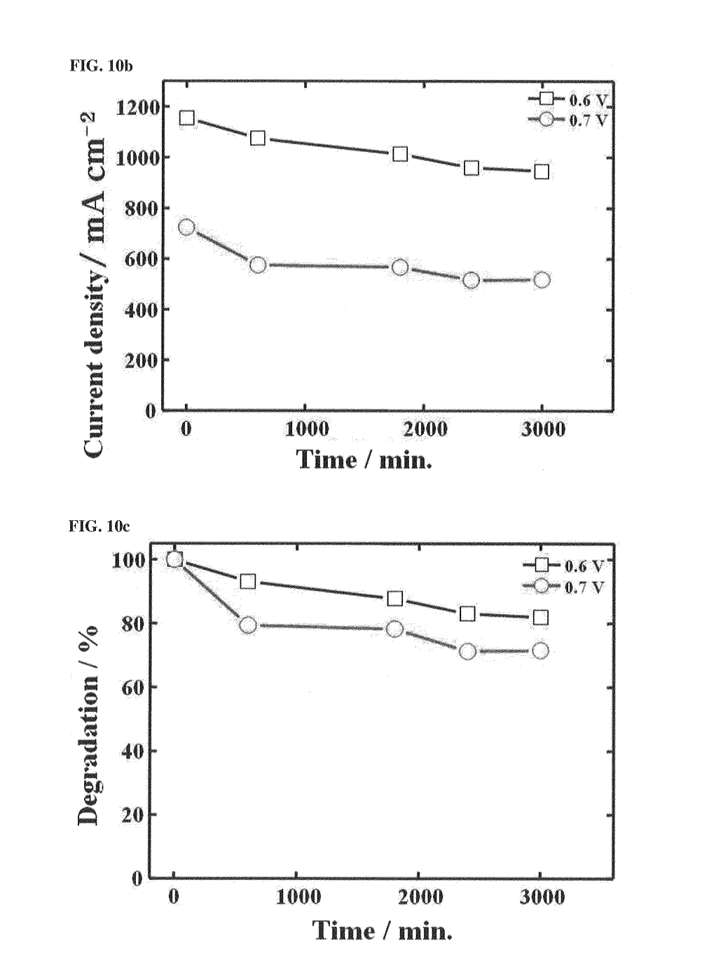

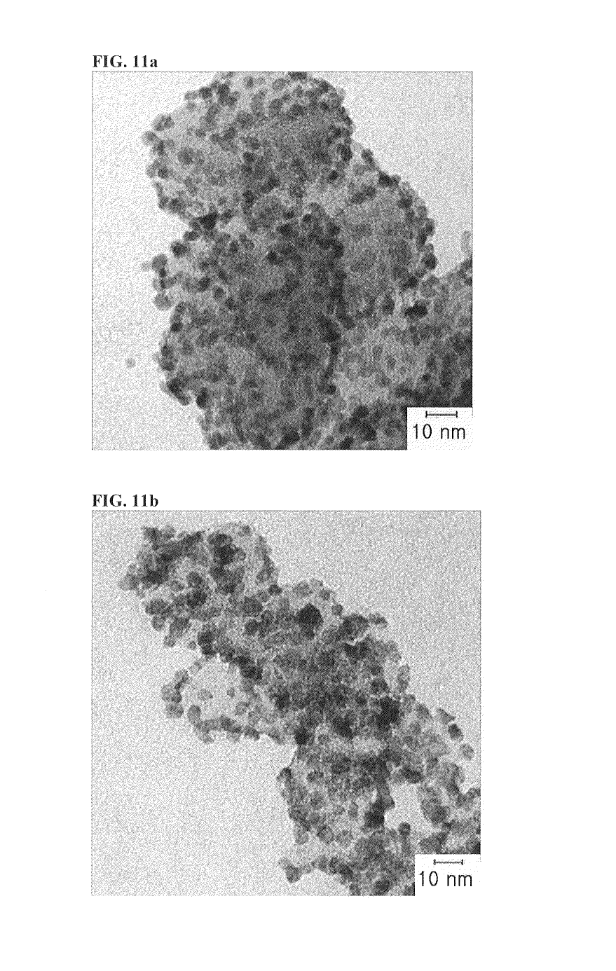

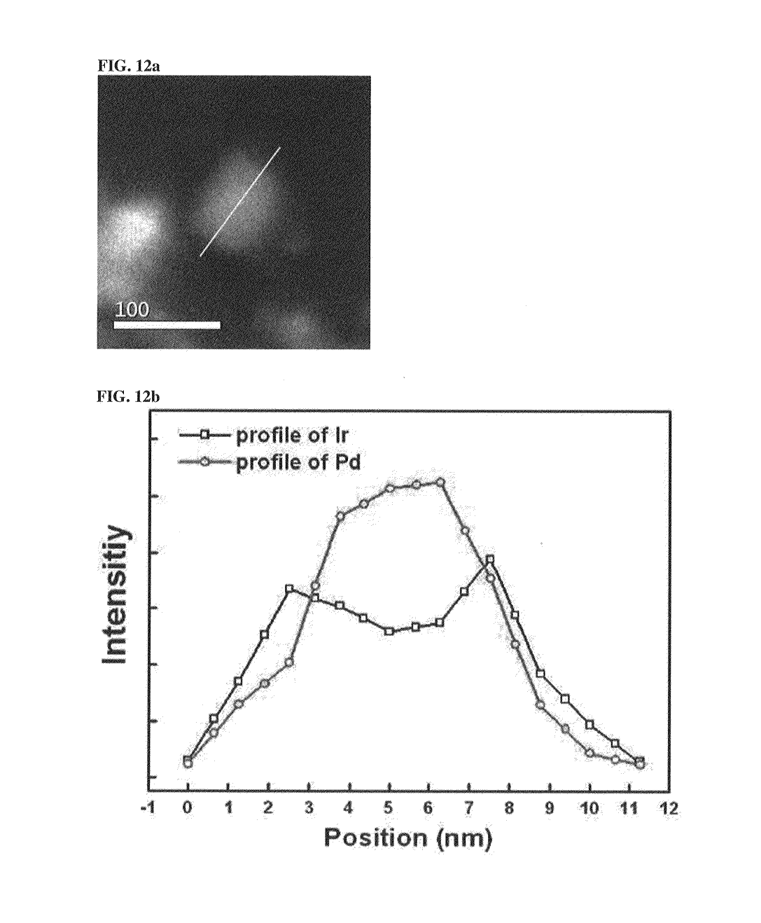

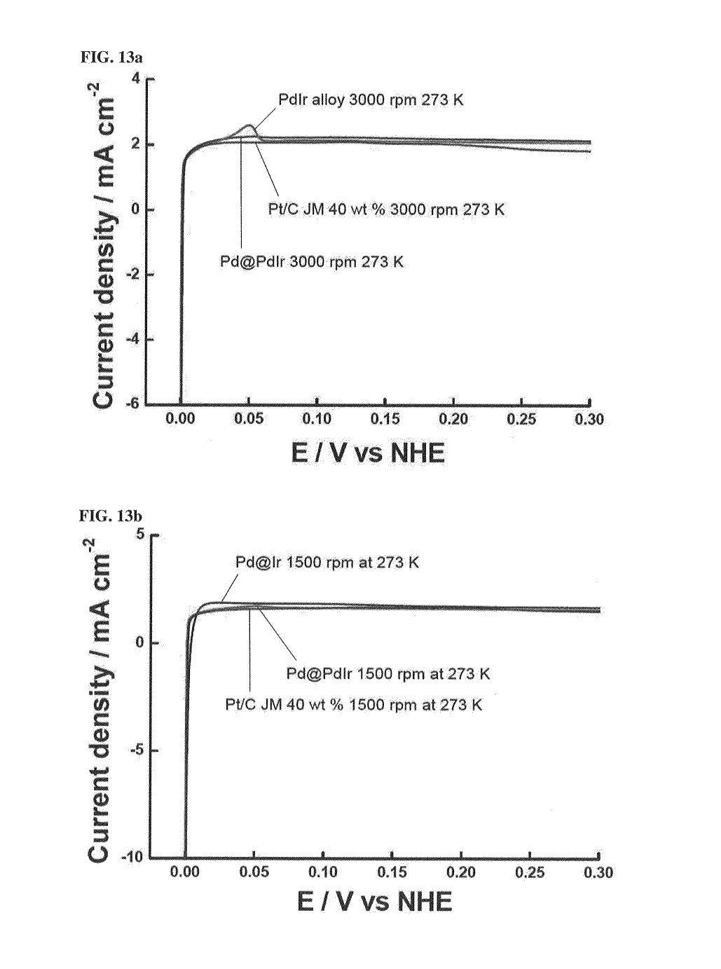

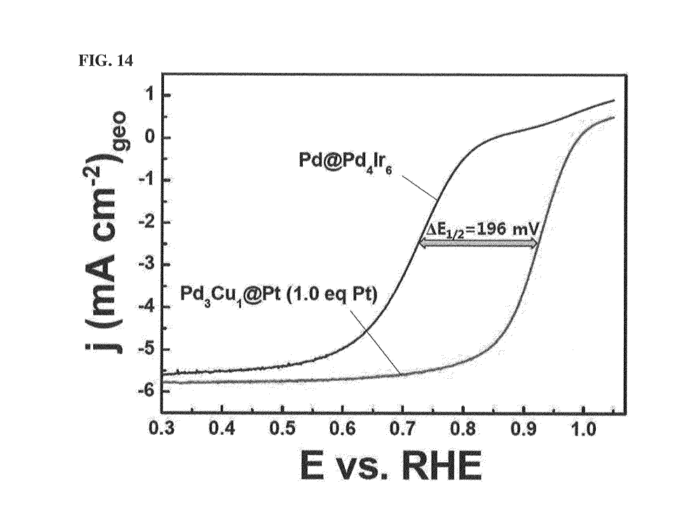

The results of FIG. 10a show that the catalyst produced in Example 2-1a is at least 5-fold more stable than the commercial catalyst, Pt/C. FIGS. 10b and 10c are graphs comparing the performance of the catalysts at 0.6 V and 0.7 V with the passage of time. The graphs show that the performance was only slightly decreased even after 500 hr. FIG. 10c shows degradation in the performance of the catalysts from the data of FIG. 10b.

Scanning Transmission Electron Microscopy (STEM) Observation

A cross-sectional STEM of Pd@PdIr/C produced in Examples 2-4 was measured along the line shown in FIG. 12a. The results are shown in FIG. 12b. As shown in FIG. 12b, the catalyst had a structure consisting of a Pd core and a Pd—Ir shell.

Evaluation of Hydrogen Oxidation Reaction (HOR) Activity

Pd@Ir/C produced in Example 2-3, Pd@PdIr/C produced in Example 2-4, PdIr alloy and a commercial Pt/C catalyst were measured for HOR activity. Half-cell tests were conducted in a 0.5 M aqueous H₂SO₄ solution saturated with H₂ in a thermostatic bath at 273° C. to evaluate the hydrogen oxidation reaction activity of the catalysts. The OOR was measured at a linear sweep of 20 mV/s from 0.0 to 0.3 V versus NHE with varying rotational speeds of an RDE from 1,000 to 3,000 rpm. The activities of the catalysts were evaluated using typical values obtained at 3,000 rpm. When the hydrogen oxidation reaction of a catalyst occurs at around 0 V and a more vertical current profile is observed upon measurement of the half potential thereof, the catalyst can be regarded as having better HOR activity. However, since the hydrogen oxidation reaction is very fast, an exact judgment can be made from a Tafel plot for the measurement of an exchange current. After the Tafel plot is prepared, the graph is extrapolated to obtain an ik value (the y-axis in the graph), which is the exchange current value. Pd@PdIr, the PdIr alloy and the commercial Pt/C were calculated to have exchange currents of 3.669 mA/cm⁻², 3.082 mA/cm⁻² and 3.383 mA/cm⁻², respectively. The core-shell structured Pd@PdIr showed slightly better performance than the commercial Pt/C.

A rotating disk electrode (RDE) half cell test was conducted at 1,600 rpm in a 0.1 M HClO₄ solution saturated with O₂ at room temperature (298 K) for 30 min to evaluate the oxygen reduction reaction activities of the reduction electrode catalysts. An electrode ink was prepared using 10 mg of each of the catalysts, 50 μl of distilled water, 100 μl of a 5 wt % Nafion solution and 1 mL of isopropyl alcohol. 7 μl of the ink was placed on a 5 mm GC electrode to form an electrode. The oxygen reduction reaction was measured at a linear sweep of 5 mV/s from 0.05 to 1.20 V versus NHE. The oxygen reduction reaction of a catalyst is typically evaluated using a half wave potential (E_{1/2}: a potential at a current corresponding to half of a limiting current density). A catalyst having a higher E_{1/2} can be regarded as having better activity for oxygen reduction reaction. FIG. 14 shows that E_{1/2} of PdCu@Pt is larger by about 196 mV than that of Pd@PdIr. This difference is significantly large, indicating that the reactivity of Pd@PdIr for oxygen reduction reaction is substantially negligible compared to that of PdCu@Pt. Another method for evaluating the activity of oxygen reduction reaction is to compare the current densities of catalysts at 0.9 V. A catalyst having a higher current density at 0.9 V can be regarded as having better activity. From FIG. 14, it can be confirmed that the current density (3.79 mA cm⁻²) of PdCu@Pt at 0.9 V is 18-fold higher than that (0.21 mA cm⁻²) of Pd@PdIr at 0.9 V, revealing that Pd@PdIr has almost no activity for oxygen reduction reaction compared to PdCu@Pt.

1. A method for preparing core nanoparticles supported on a support for a core-shell structured electrocatalyst, comprising
(a) reacting a support with a precursor of at least one core-forming metal in an ether-based solvent.

2. The method according to claim 1, wherein the reaction in step (a) is carried out at 80 to 120° C.

3. The method according to claim 1, wherein the core is composed of an alloy of Pd and Cu, and step (a) is carried out at room temperature.

4. The method according to claim 1, wherein the ether-based solvent is selected from benzyl ether, phenyl ether, dimethoxytetraglycol, furan-based aromatic ethers, and mixtures of two or more thereof.

5. A method for producing a core-shell structured electrocatalyst for a fuel cell, comprising
(a) reacting a support with a precursor of at least one core-forming metal in an ether-based solvent to obtain core nanoparticles supported on the support, and
(b) reducing a precursor of at least one shell-forming metal using an ester-based reducing agent in a solution in which the core nanoparticles supported on the support are dipped or dispersed.

6. The method according to claim 5, wherein the ether-based solvent is selected from benzyl ether, phenyl ether, dimethoxytetraglycol, furan-based aromatic ethers and mixtures of two or more thereof, and the ester-based reducing agent is a Hantzsch ester of Formula 3: 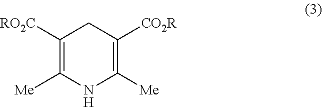
wherein each Me represents a methyl group and the two R groups, which are identical to or different from each other, each independently represents a C₁-C₄ alkyl group, or a derivative thereof.

7. The method according to claim 5, wherein the at least one core-forming metal is selected from Pt, Pd, Ir, Ru, Rh, Os and transition metals, and the at least one shell-forming metal is selected from Pt, Pd, Ir, Ru, Rh, Os and transition metals.

8. The method according to claim 5, wherein the at least one core-forming metal is selected from Pt, Pd, Ir, Ni and Cu, and the at least one shell-forming metal is selected from Pt, Pd, Ir, Ni and Cu.

9. The method according to claim 5, wherein the reaction in step (a) is carried out at 80 to 120° C.

10. The method according to claim 5, wherein the core is composed of an alloy of Pd and Cu, and step (a) is carried out at room temperature.

11. The method according to claim 5, wherein the at least one core-forming metal is Pd, and the shell is composed of an alloy of Pd and Ir.

12. A core-shell structured electrocatalyst for a fuel cell, comprising (A) a support, (B) core nanoparticles supported on the support, and (C) a shell layer selectively formed on the surface of the core nanoparticles,
wherein the core is composed of at least one metal or alloy selected from Pt, Pd, Ru, Rh, Os, transition metals and alloys of two or more thereof, and
the shell layer consists of one or more layers, each of which is composed of at least one metal or alloy selected from Pt, Pd, Ir, Ru, Rh, Os, transition metals and alloys of two or more thereof.

13. The core-shell structured electrocatalyst according to claim 12, wherein the core is composed of at least one metal or alloy selected from the group consisting of Pt, Pd, Ir, Ni, Cu and alloys of two or more thereof, and the shell layer is composed of at least one metal or alloy selected from the group consisting of Pt, Pd, Ir, Ni, Cu and alloys of two or more thereof.

14. The core-shell structured electrocatalyst according to claim 12, wherein the core is composed of an alloy of Pd and Cu, and the shell layer is composed of Pt.

15. The core-shell structured electrocatalyst according to claim 12, wherein the shell layer consists of a first shell layer directly formed on the core and a second shell layer formed on the first shell layer, and the core, the first shell layer and the second shell layer are composed of Pd, Au and Pt, respectively.

16. The core-shell structured electrocatalyst according to claim 12, wherein the core is composed of Pd and the shell layer is composed of an alloy of Pd and Ir.

17. An electrode for a fuel cell, comprising the core-shell structured electrocatalyst according to claim 12.

18. A cathode for a fuel cell, comprising the core-shell structured electrocatalyst according to claim 12.

19. An anode for a fuel cell, comprising the core-shell structured electrocatalyst according to claim 16.

20. A core-shell structured electrocatalyst for a fuel cell, comprising (A) a support and (B) a plurality of core-shell structured catalysts supported on the support wherein the cores are composed of Pd and the shells are composed of an alloy of Pd and Ir.

21. An anode for a fuel cell, comprising the core-shell structured electrocatalyst according to claim 20.
